(19) United States
(12) Patent Application Publication
(10) Pub. No.: US 2007/0009667 A1
(43) Pub. Date: Jan. 11, 2007

(54) Apparatuses and methods for producing surface and subsurface alloy and diffusion zones to reduce friction and wear and products resulting therefrom

(75) Inventors: Richard C. Gould, Spokane, WA (US); Gary E. Huggins, Spokane Valley, WA (US); Randy A. Gregory, Spangle, WA (US)

Correspondence Address: RANDY A. GREGORY;GREGORY I.P. LAW, P.O. BOX 31090, SPOKANE, WA, 99223-3018, US

(73) Assignees: MetalGard Engineering Corp.; Metalgard Corp.

(21) Appl. No.: 11/354,311

(22) Filed: Feb. 14, 2006

Related U.S. Application Data
(60) Provisional application No. 60/655,653, filed on Feb. 22, 2005.

(51) Int. Cl. B05D 1/02

(52) U.S. Cl. 427/427.5; 118/500

(57) ABSTRACT

Apparatuses and methods for treatment of objects and the resulting products. The treatments are directed to improving friction, wear and service life. Methods may include decontaminating the surface being treated. The treated surface is texturized to better receive treatment materials jetted toward and impinged against the surface to release energy to form alloys. The jets may include carrier and/or impact particles to facilitate treatment and alloying. The materials may additionally infuse, diffuse, be captured by texture or folding or otherwise be incorporated in the substrate treatment area so as to form a skin which includes the treated surface and a subsurface zone which have the improved characteristics or other desired attributes. The treatments and apparatus therefor produce such alloying and incorporation of treatment materials without increasing the size of the object being treated.

### REFERENCE TO RELATED APPLICATIONS AND/OR PATENTS

This application claims priority to U.S. Provisional Patent Application Ser. No. 60/655,653, filed Feb. 22, 2005, pursuant to 35 U.S.C. 120.

### TECHNICAL FIELD

This invention relates to apparatuses and methods for treatment of objects to provide both surface and subsurface diffusion and alloy layers which provide a surface and subsurface wear layer of reduced friction and improved wear characteristics.

### BACKGROUND OF THE INVENTION

Components manufactured from various materials are often fabricated or otherwise produced such that the material properties at the surface of the component are the same as the properties of the substrate material. The substrate material may be either the entire body of the object or a substantial layer formed upon a larger object of different material comprising the remainder of the component or other object.

In some cases, it may be desirable to provide surface properties that differ from the substrate material properties. In particular, it is desirable to reduce friction, decrease wear, increase service life, improve performance of a device using the treated object, or possibly otherwise affect the properties demonstrated by the treated object.

A variety of processes have been developed to alter properties at a material's surface. A few examples of such methods include atomic layer deposition, physical vapor deposition, coating processes, cladding and others. However, deposition techniques, applied coatings, and other known coating, cladding or layering methods exhibit problems of chipping, cracking, peeling, or other separation of the added layer.

Another limitation that has been consistently problematic to this area of technology has been that the processes significantly change the finished dimensions of a treated article. Many machine parts have a very narrow range of acceptable dimensional tolerance. Prior approaches have caused increases in the dimensions of components, or otherwise changed dimensions.

This change in dimensions caused by the prior processes has led to the need to consider these changes in dimensions during the engineering of the parts that are to be coated. This design accommodation for the thickness of the coating being used may not result in a satisfactorily finished product. Even when design considerations are made to compensate, the addition of a coating or other layer or layers may have problems due to the added thickness and non-uniformity in the thickness of applied coatings. Thus, the dimensional tolerances are often missed even though design considerations have been made.

There is a long-felt need in this art for improved technologies and apparatuses for processing, and even more preferably, automated processing of parts subjected to friction and wear. Improved technologies are needed to provide reduced friction, improved wear resistance and improved service life, while also not causing a change in the dimensions of the component or other object being treated that will cause problems.

A further problem demonstrated by some of the known deposition, coating, or other antifriction surfacing methods yield toxic by-products which may cause environmental problems. Such environmental problems have thus impeded the development of techniques for treating objects to provide reduced friction, improved wear or other desired characteristics while maintaining the desired dimensions of the treated objects.

One or more of these and possibly other problems are at least in part addressed by the techniques described herein.

### SUMMARY OF CERTAIN EMBODIMENTS OF THE INVENTIONS

One or more preferred versions of the inventions are now summarily described to provide a limited explanation of some of the inventions according to this document.

According to one aspect of the invention, a surface layer treatment includes impinging a substrate with a treatment material or materials which are jetted upon the substrate surface. If properly prepared, the surface which is impinged upon by the jet or jets of the treatment materials cause alloys to be formed upon the surface and into a subsurface alloy and diffusion zone.

The jetting and impingement of the materials onto the treated surface cause various surface effects to occur. Depending on the surface and treatment(s) used, these may include roughening, uniformizing of surface characteristics, such as roughness, alloying, distortion and/or folding of minute surface features or other surface and subsurface effects. Such effects may thus serve by carrying portions of the treatment materials onto the surface and into the subsurface diffusion and alloy zone. Such may thereby perform by enhancing the surface and/or subsurface, such as by incorporation of treatment materials along with increasing the depth and extent of alloy reactions that occur, infusion which may occur, diffusion which may occur, or other incorporation of one or more treatment material or components thereof.

The resulting surface and/or subsurface alloy and diffusion zone or zones are thus provided with a permanent change of composition which renders the treated surface and subsurface zone with reduced friction, reduced wear rates, increased service life and in some implementations may also provide other advantages or other enhancements or desirable characteristics, which may not now be appreciated. Thus, as the surface wears, the enhanced properties are still present despite wear into the subsurface zone, thus causing the treatment to improve performance over an extended service life.

According to some implementations or aspects of the inventions, a surface and subsurface alloying method includes decontaminating the substrate surface being treated. The decontaminating may be performed with a suitable cleaning or other decontaminating agents or materials, such as dry materials, liquid materials such as solvents, or other decontaminating, cleaning and/or solubilizing materials or other agents. This decontaminating step may not be needed if the treated surface has been produced without contamination or has otherwise been previously decontaminated, or whatever contamination present is not problematic. If a dry or particulate decontamination material or other subsequently undesirable materials are used, then a solvent cleaning or other suitable cleaning technique may be desired to clean the decontamination material or agent from the workpiece. Where the workpiece is provided in suitably clean, uncontaminated condition, then one or more of these steps may not be needed.

The decontaminated and cleaned treatment surface which may have been decontaminated and/or cleaned is also preferably prepared to provide a proper texture, roughness, or other desired surface physical condition. This is advantageously done after any decontaminating and/or cleaning step or steps. This texturizing, roughening, or other physical surface conditioning may also reduce or minimize the effects of decontamination and/or any cleaning step or steps which may have been performed. The type and degree of texture or textural roughness may vary dependent upon the particular substrate, texturizing or conditioning, and the treatment material or materials to be employed.

One preferred form of surface preparation or surfacing provides increased and uniform roughness. This may be accomplished in a number of different ways. A preferred manner of surface texture preparation may employ jetting one or more jets or streams of abrasive, abrading, smoothing, or other desired conditioning material or materials upon the surface being treated. The materials used may include a variety of surface conditioning materials now known or hereafter developed in this art. Some examples are described below. Such step or steps may use materials which are incorporated into the surface and subsurface alloy and diffusion zone, or other subsurface treatment affected zone.

Upon proper preparation of the treated surface to provide the desired texture or roughness, then the surface is treated in one or more treatment steps which add desired chemicals to the surface and cause alloying of not only the surface but in a subsurface alloy and diffusion zone which is alloyed and affected by the impingement of the treatment materials onto and into the treated surface and subsurface zones. The treatment also preferably causes diffusion and other incorporation of part or all of one or more of the treatment materials, such as by folding, alloying, diffusion, and possibly other incorporation mechanisms. Such mechanisms of incorporation may be effective to cause solid state reactions to effect alloying or other transforming or conditioning of some or all of at least one of the treatments done to the workpiece.

In one form of the inventions, the desired roughness or texture is provided by texturizing materials which are jetted at the treated surface to impinge thereon and impact the workpiece surface. For example, or in particular, such may be done at one or more treatment areas upon a workpiece, such as an article, object, assembly, or apparatus. The impacting of the particles or other pieces of texturizing or conditioning material preferably also causes the surface to be physically worked to achieve a desired degree of roughness, texture, hardening or other conditioning. Such conditioning is dependent upon the substrate and texturizing or other conditioning material or materials being used.

When such conditioning involves the impact metal shot or other denser material or materials, it may also cause work hardening of the workpiece surfaces being treated. The amount of work hardening will depend on the work-hardenability of the substrate and the type of materials used in the texturizing or other physical conditioning step or steps used. It may also be affected by any previous decontamination and/or cleaning step(s) performed because such steps may have a resulting effect on the workpiece surface.

Depending upon the initial surface formation and texture, the step or steps of texturizing to the desired roughness, texture, or other condition may involve smoothing the surface, roughing the surface, or other surface character changing or transforming step(s). In some instances the texturizing or other conditioning may both smoothen ridges or high points (such as between machining grooves) and yet roughen other areas that are otherwise smoother than what is desired for the substrate and treatment material or materials being used in the process. The type of surface characteristics, features and/or roughness of the surface that is desired and commensurate with the subsequent application of one or more antifriction and other treatment materials may vary significantly, depending on the substrate and treatment materials used.

The texturizing, surfacing, or other surface conditioning of the surface being treated may be accomplished using a single material or multiple materials in one or more stages. Texturizing may be performed along with a carrier and/or impactive material. The carrier is often chosen so that it adds mass in the form of a particulate which is denser than other materials being used in the treatment material or materials. Such denser carrier particles increase the amount of energy released upon impact from the kinetic energy of the jetted material or materials.

The treatment materials may include one or more active alloying chemicals which may include various mixtures and compounds providing part or all of the alloying and incorporation of materials into the alloy and diffusion zone. The treatments may be performed in one or more steps.

Although this summary sets out some forms, features, aspects or considerations, it must be interpreted as setting forth only part of the inventions described herein, with others being set out in other parts of this document.

### BRIEF DESCRIPTION OF THE DRAWINGS

Preferred forms or embodiments of the inventions are explained and characterized herein with reference to the accompanying drawings. The drawings also serve as part of the disclosure of the inventions of the current document. Such drawings are briefly described below.

FIG. 1 shows cross-sections through untreated (A) and treated (B) pistons at 2,000× magnification.

FIG. 2 shows cross-sections through untreated (A) and treated (B) pistons at 5,000× magnification.

FIG. 3 shows cross-sections through untreated (A) and treated (B) pistons at 10,000× magnification.

FIG. 4 shows pistons used in a fuel injector, such as for a diesel engine, in the untreated (A) and treated (B) conditions.

FIG. 5 shows scanning electron micrographs of the untreated piston surface at 1,000× (A) and 2,000× (B) magnifications.

FIG. 6 shows scanning electron micrographs of the treated piston surface at 1,000× (A) and 2,000× (B) magnifications.

FIG. 7 is a Venn diagram showing, by way of visualization example and not by way of limitation, possible interrelationships between at least some of the factors affecting methods according to various aspects of the inventions described herein.

FIG. 8 is a cross-sectional diagram showing the substrate before cleaning and/or any initial setting and impingement according to the invention.

FIG. 9 is a cross-sectional diagram showing the orientation of the nozzle with respect to the substrate surface according to the invention.

FIG. 10 is a cross-sectional diagram showing the substrate following a second impingement process which alloys a surface layer on and extending into the substrate according to the invention.

FIG. 11 is a SEM at 40,000× of the surface and cross-sectional view illustrating the inclusion of minute nodules of treatment materials and a peninsula of surface or substrate material which in instances is folded over to incorporate treatment materials into the subsurface alloy and diffusion zone.

FIG. 12 is a side diagrammatical view showing a preferred automated system for performing processes according to some forms of the inventions.

FIG. 13 is an enlarged side elevational view showing a workpiece held by a workpiece conveyor.

FIG. 14 is a top view of the subject matter of FIG. 13.

FIG. 15 is partial top diagrammatic view showing an outfeed mechanism used in the system of FIG. 12.

### DETAILED DESCRIPTION OF CERTAIN PREFERRED EMBODIMENTS AND BEST MODE

Introductory Notes

The readers of this document should understand that the embodiments shown and described herein may rely on terminology used in any section of this document and other terms readily apparent from the drawings and language common therefor. Language common for various aspects and features of the inventions shown or otherwise described herein may be provided by dictionaries such as the widely know Webster's Third New International Dictionary (Meriam-Webster Incorporated), The Oxford English Dictionary (Second Edition) (Clarendon Press), The Century Dictionary (available from Global Language Resources, Inc. on CD-ROM and on-line at http://www.global-language.com/century/), and The New Century Dictionary (Appleton-Century-Crofts 1952), all of which are hereby incorporated by reference for interpretation of terms used herein and for application of appropriate words to various features and aspects shown or otherwise described herein.

Also incorporated by reference hereinto are all priority applications referred to above in the section entitled, “Reference to Related Applications and/or Patents”.

This document is further premised upon using one or more terms with one embodiment that may also apply to other embodiments for similar structures, functions, features and aspects of the invention. Wording used in the claims is also descriptive of the invention and the text of the claims is incorporated by reference into the description entirely in the form of the claims as originally filed. Terminology used with one, some or all embodiments may be used for describing and defining the technology and exclusive rights associated herewith.

Methods

Introductory Discussion of Methods

According to certain aspects of the inventions, the surface of a substrate material or materials is treated to create a surface layer containing alloying, diffusion, or other incorporation of at least one treatment material. Some preferred methods include jetting at least one jet of treatment material(s) and impinging a substrate with a first treatment material or materials contained in the impinging jet or jets.

In some versions of the inventions the first treatment may be a decontaminating step to remove contaminating materials from the surface of a workpiece. It is also possible that such decontaminating may also serve by providing incorporation of material into the treated zones. Such decontaminating is used as needed, such as if the workpiece may have or does have contaminating materials thereon which adversely affect the effectiveness of a subsequent treatment step or steps.

Methods according hereto may further include selecting a substrate material which is suitable for treatment. Exemplary treatment materials are discussed in greater detail below. The preferred treatment materials may include carrier and/or impact material(s) which facilitate the treatment(s). Such material is frequently provided to improve release of kinetic energy upon impact and facilitates alloying and diffusion by providing the treated surface area to carry or incorporate other parts of the treatment materials. The process parameters used in the jetting and impingement processes may be chosen such that they change chemical composition on the surface and into the subsurface zone of alloying, diffusion, infusion, or other incorporation mechanisms. The surface and subsurface layers are formed from the untreated substrate so as to prevent enlargement of the workpiece, object or other device being treated.

Substrate Materials

The surface layer treatment methods may be applied to a variety of substrates and are in particular appropriate for metal substrates. It is also possible that the methods may be useful for ceramics and polymers. However, the characteristics of the layer formed may be different from that of metal substrates. Different processing parameters, carrier materials, impact materials and other treatment materials may be preferred depending on the type of substrate being treated and the treatment(s) desired.

Application of the method to metals has been found to be particularly significant in reducing the coefficient of friction associated with a metal surface. In standard pin on disk tests performed on untreated and treated samples of 52100 alloy steel, the untreated sample had a coefficient of friction of approximately 0.26, while the treated sample had a coefficient of friction of approximately 0.10. The treated samples had a 62% decrease in the coefficient of friction compared to untreated samples. The wear scar diameter, also measured in the pin on disk test, was 0.76 mm for the untreated sample and 0.35 mm for the treated sample. Smaller diameter wear scars indicate less friction during the test. The treated samples had a 54% reduction in wear scar diameter compared to untreated samples.

In one example given below, the substrate metal contained approximately 94% iron, approximately 2% chromium and approximately 4% silicon. The surface and subsurface layer on the treated piston contained approximately 65% iron, approximately 27% sulfur, approximately 7% aluminum and approximately 1% silicon.

Because of the increased lubricity, properly treated substrate materials may be metallic parts used in metal-to-metal moving contact with improved performance. Examples of such are components such as punches, fasteners, and metallic parts of internal combustion engines, other machinery or a variety of suitable workpieces. Substrate metals may include aluminum and its alloys, titanium and its alloys, copper and its alloys, steel and other ferrous alloys or metal materials, and a wide variety of combinations thereof which demonstrate suitable results. The processes may also prove to be useful on ceramic, polymer or other non-metallic substrates in some applications.

As may be appreciated from features and the aspects of the invention described herein, the novel methods may be applied to a variety of substrates where a desire exists to treat and change the chemical composition of the substrate surface into a layer or skin by alloying and incorporating treatment materials, or components thereof, inducing alloys, compounds, mixtures or other incorporation resulting therefrom into the surface and subsurface layers.

Decontaminating the Substrate

It is believed that the decontaminating or decontaminating cleaning using a first impingement may also be performed using materials which may in some processes increase or maximize the opportunity for texturizing, penetration or other incorporation of the treatment material(s) into the substrate. Further, minor surface inconsistencies, such as machining and/or forming marks from prior fabrication methods or other inconsistencies, may decrease the effectiveness of treatments. Reducing the presence of surface inconsistencies at an early stage of the methods in some implementations of the inventions may thus result in improved treatment and subsurface layer formation. Initial or early stage jetting and impingement of suitable material or materials may help provide a surface uniformizing step that provides a more uniform surface which allows for more complete penetration of treatment material into the surface of the substrate. This, in turn, increases the homogeneity of the surface and subsurface layers and establishes or imposes uniformity in the surface properties produced by this treatment.

Similarly, surface impurities and/or oils may be present on a substrate from prior fabrication methods. Surface impurities and/or oils may act as a barrier which reduces penetration of treatment material into the surface. Also, surface impurities and/or oils may lubricate the substrate, allowing treatment materials to ricochet from the substrate without reacting with the surface or substrate, diffusing into the substrate, or otherwise be incorporated into the substrate. The interaction of treatment material with the surface may also be affected if the momentum associated with the collision of any impact and/or carrier material and the surface is changed by the presence of surface impurities, such as oils on the surface.

Cleaning Substrate

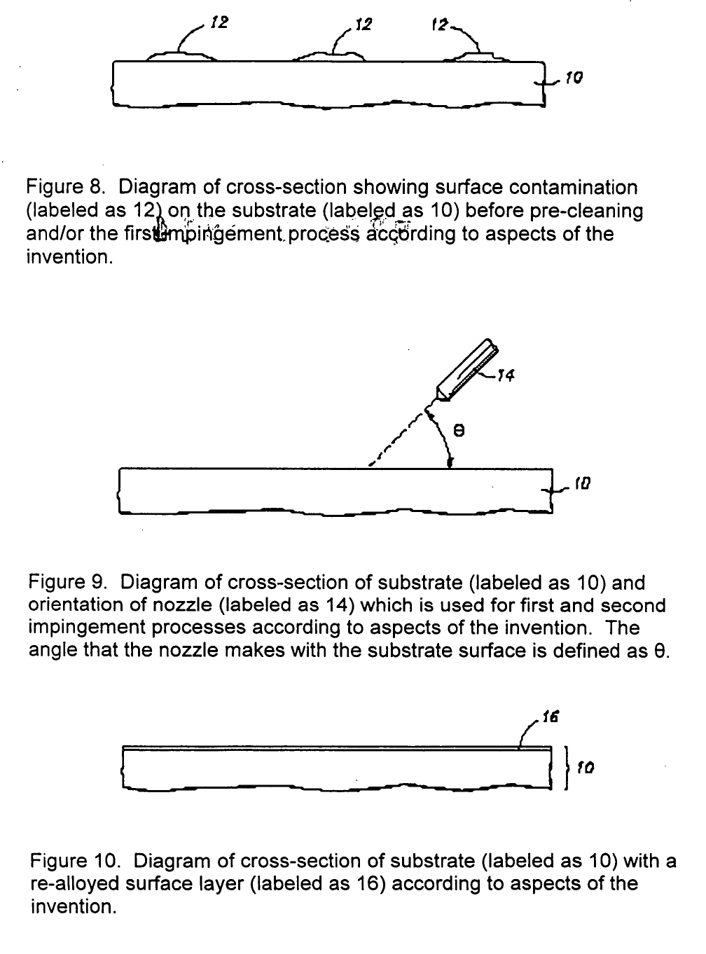

A preferred step used in at least some methods according to the invention includes cleaning the substrate or substrate area to be treated. This may involve using a suitable cleaning material or materials. FIG. 8 shows a substrate (labeled as 10) on which surface debris (labeled as 12) exists prior to cleaning.

It is believed that cleaning the substrate maximizes the opportunity for penetration of the treatment materials into the substrate. Also, minor surface inconsistencies, such as machining and/or forming marks from prior fabrication methods, may decrease the effectiveness of alloying, diffusion, infusion or incorporation, even though the presence of these surface inconsistencies may or may not detrimentally affect conventional coating methods. Some experience indicates that reducing the presence of surface inconsistencies by cleaning with a dry material jetted and impinging thereon results in improved alloying and/or incorporation results. Also, cleaning and impingement helps provide a uniform surface which allows for more complete penetration of treatment material(s) onto and into the surface of the substrate. This, in turn, increases the homogeneity of the treated surface and subsurface layer and establishes increased uniformity in the desirable surface and subsurface properties produced by this treatment.

Similarly, surface impurities and/or oils may be present on a substrate from prior fabrication methods. Surface impurities and/or oils may act as a barrier which reduces penetration of treatment materials into the surface. Also, surface impurities may lubricate the substrate, allowing modifying media to ricochet from the substrate without fully reacting with the substrate. The interaction of treatment material with the surface may also be affected if the momentum associated with the collision of the treatment material and the surface is changed by the presence of surface impurities present on the surface. Lack of sufficient kinetic energy associated with the collision may hinder adequate alloying of the surface.

Cleaning may advantageously be performed using a variety of solvent or cleaning solvents now known or hereafter developed to solubilize any undesired materials present on the surfaces being treated.

Texturizing Substrate

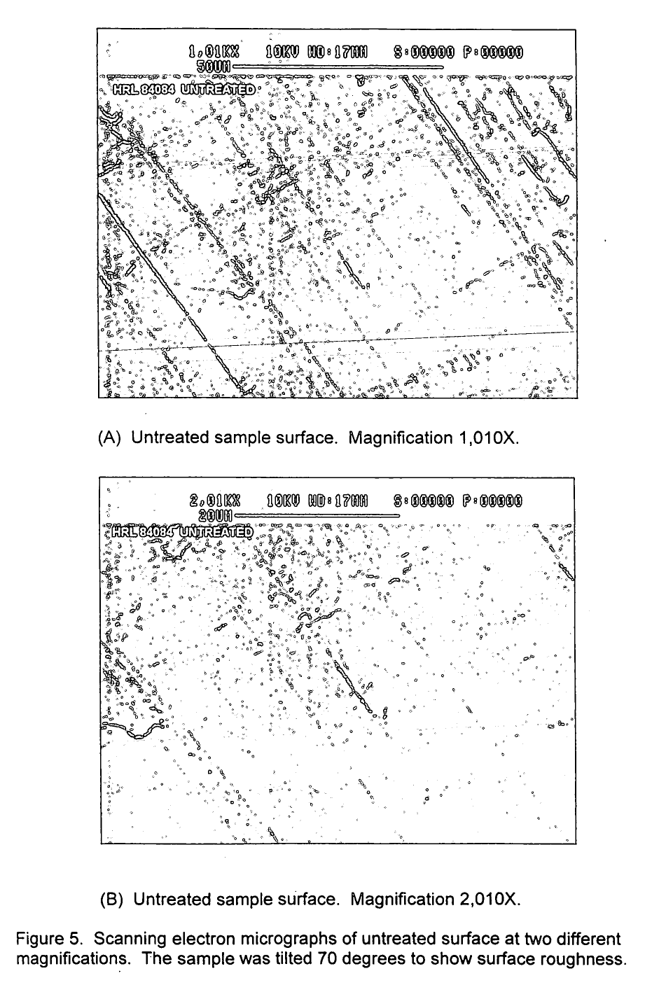

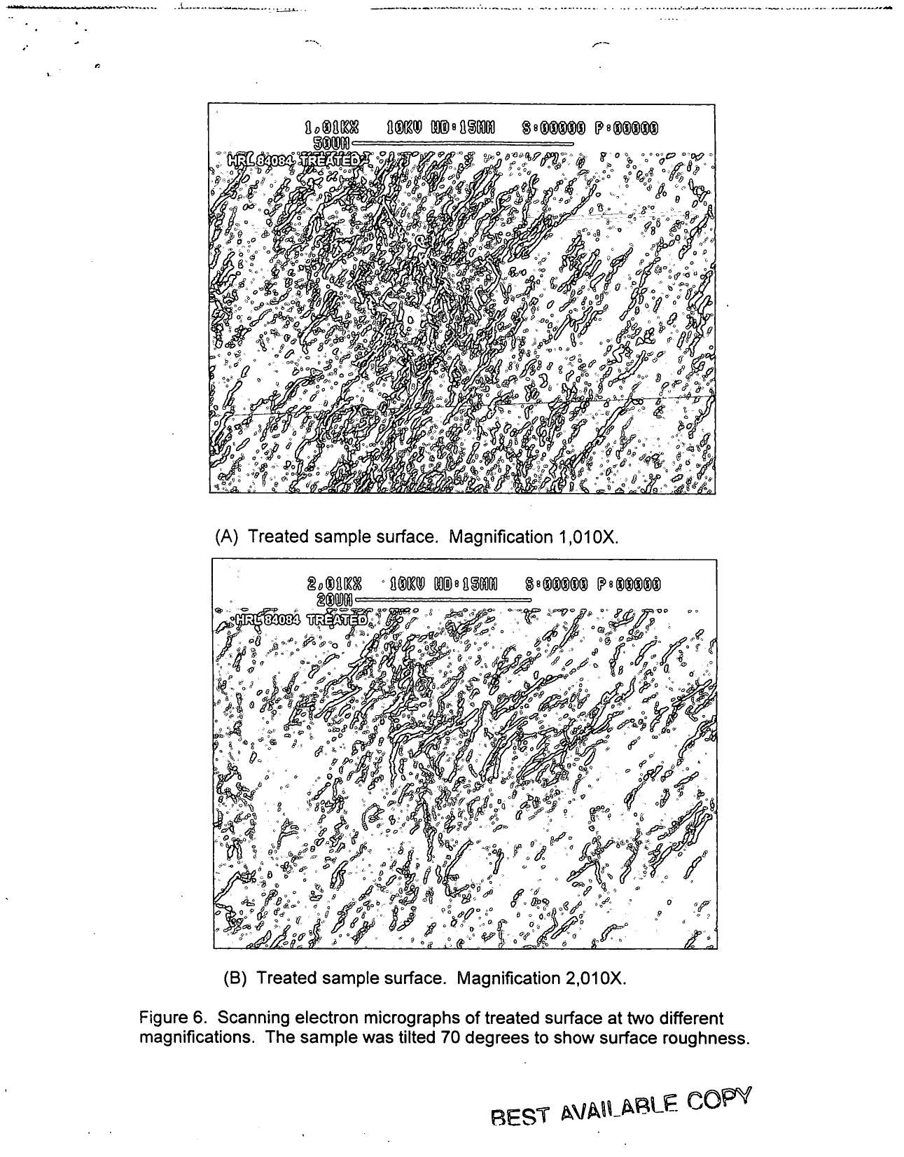

Higher magnification micrographs of untreated and treated piston surfaces are shown in FIGS. 5 and 6, respectively. The treated surfaces shown in FIG. 6 have a higher surface roughness than the non-texturized surfaces shown in FIG. 5. The rougher surfaces produced by the texturizing treatment help to reduce the actual area of direct metal contact between two mating parts. It may also enhance entrapment of lubricants within interstices existing between other surface features. The reduction in area of metal contact, metal-to-metal contact, and/or entrapment of lubricant(s) may realize the benefits of increasing lubricity, reducing the coefficient of friction, reducing wear and extending service life.

Impact and/or Carrier Materials

A few examples of impact or carrier materials include, but are not limited to, copper slag, ground glass, corn cob, plastic, Al₂O₃, coarse staurolite, sand, NaHCO₃, synthetic olivine pyroxene, walnut shell, apricot pit, gravel, iron, SiC, BC, diamond powder, steel shot, glass beads, garnet, combinations thereof, or other suitable impact and/or carrier materials now known or hereafter developed.

The treatment material or materials may include at least one material selected from the group consisting of molybdenum disulfide, Ti, W, Ru, C, Ta or other sulfides, V, and polytetrafluoroethylene (PTFE). As may be appreciated from the aspects of the invention described herein, other treatment materials may be desirable or useful in performing the novel processes according to the inventions taught herein.

Mixing of Treatment Materials

In the process of mixing treatment and/or impact materials and/or carrier materials, some mixing apparatuses and material types create static electricity. The static charge may cause agglomeration of the treatment material(s) so that it or they are not uniformly distributed within the mixture. During processing, such agglomerated materials tend to adhere to the substrate surface instead of becoming incorporated into a subsurface layer. Techniques according to at least some forms of the invention can be used for minimizing the buildup of static charge. These for example may include using transmission hoses from mixing apparatuses, to impingement apparatuses that are non-static and/or electrically grounded.

De-Staticization

Instead of a rotary-type of blending apparatus, a split mixing apparatus, such as a V-mixer now known, or other type hereafter developed, tends to reduce static charge buildup prior to introduction into the treatment chamber. In addition, the treatment material(s) tend to adhere to the carrier media or impact media, or both, better when prepared in a split mixing apparatus. Such or an equivalent may provide a more uniform distribution of the treatment material in the carrier media. A more uniform distribution of treatment material in the carrier media may contribute to a more uniform alloying and incorporation of treatment materials into a surface layer and into the subsurface layer or zone formed in the substrate.

Jetting and Streaming of Treatment Materials

FIG. 9 shows the orientation of nozzle at a nozzle angle of θ with respect to the substrate surface. If the substrate surface is curved, θ is defined with respect to a tangent line to the surface at the point being impinged upon. The diagram in FIG. 9 is a general depiction of the apparatus used in the first or second impingement processes showing at least one stream of treatment materials being streamed at the workpiece. Depending on the curvature of the surface, the nozzle angle may vary throughout a surface alloying method as the nozzle travels across the substrate during the first, second or subsequent impingement processes.

A preferred second impingement occurs at a nozzle pressure from 10 to 200 pounds per inch² (psi), more preferably 20 to 100 psi, (from 138 to 689 kilo-pascals or kPa). Although this nozzle pressure may be suitable, nozzle pressure may range from approximately 10 to 100 psi, more preferably 20 to 60 psi, or even more preferably, from approximately 30 to 60 psi.

The volumetric flow rate through the nozzle during the first, second or other impingement ranges from approximately 5 to 2000 standard cubic feet per minute (scfm), even more preferably 6 to 1900 standard cubic feet per minute (scfm) (0.17 to 54 standard cubic meters per minute or scmm). The nozzle size used was from approximately 1/16″ to approximately ¾″ (from 1.6 to 19 millimeters).

Based on the volumetric flow rate in combination with the nozzle size, the exit velocity of the stream being jetted from the nozzle may be approximately calculated. Nozzle pressure is an indicator of exit velocity since the velocity of the modifying media increases as the nozzle pressure increases for the same processing equipment. However, the actual velocity of modifying media may also depend on equipment configuration, such as nozzle size and volumetric flow rate.

Impingement and Application of Treatment Materials

A variety of techniques may be used to impinge a substrate with a carrier media while providing a treatment material. Shot peening and grit blasting constitute but two of the possible techniques with shot peening being one of the preferred techniques. The concept behind impinging a substrate with a carrier media while providing a treatment material involves using the kinetic energy in the carrier media to incorporate treatment material into the surface layer. The novel methods including this method of incorporation do not produce a substantial dimensional change in the substrate or workpiece size.

The first impingement may include dry blasting the substrate with an abrasive cleaning media entrained in a carrier gas. The cleaning media may be an abrasive material, which is applied at a nozzle, stream or impingement angle from 0° to 90°, more preferably 10° to 90°, even more preferably 20° to 80°. The second impingement of the substrate may use a mixture containing a suitable treatment material and carrier media, which is entrained in a carrier fluid, preferably a carrier gas.

Energy Transformation

A distinguishing aspect of this invention is that the treatment material or materials used in practicing methods according to this invention are incorporated into both a surface layer and subsurface layer by alloying, diffusing, infusing or otherwise incorporating elements, compounds or portions thereof without increasing the dimensions of the workpiece. This has remained a long-felt need in the art.

The kinetic energy of impact and/or carrier materials can be calculated or estimated with the following equation: Kinetic Energy=½ mv², where m is the mass of the shot with materials thereon or other suitable impact particles in units of kilograms, v is the velocity of the impact materials in units of meters/second, and the calculated kinetic energy is in units of Joules. The kinetic energy associated with 1 kilogram of impact media with a velocity of 190 m/s is 18050 Joules.

The collision between the jetted materials streamed at the substrate surface causes energy transformation to occur. Kinetic energy will be partly transferred to the substrate when the materials are impacting the surface of the substrate. In the case of an impact and carrier media coated with MoS₂ particles, thermodynamic calculations indicate that the energy transferred to the substrate is sufficient to dissociate or partly dissociate the MoS₂ present on the surface of the impact and carrier media into smaller molecular or atomic particles, such as individual molybdenum and sulfur atoms, or other portions or resultants from the impinging, colliding material(s).

Incorporation of Treatment Materials into Surface

After selecting a desired type of substrate and an end design specification for surface properties, sufficient information exists herein to enable one of ordinary skill to modify a substrate composition to produce a skin layer by incorporating suitable treatment material(s) thereinto. Using statistical design and experimental techniques with the teachings and factors identified herein, improvement in surface properties can be achieved compared to properties of the substrate material and/or properties of a common added surface layer.

Infusion of Treatment Materials into Sub-Surface Zone

The second or other impingements also may desirably cause some of the streamed materials to be infused through the surface and into a sub-surface zone. Also, it is not now certain what all mechanisms are which cause such alloying, infusion, diffusion and incorporation to occur. Some are believed to be caused by alloy reactions. Others may be caused by mechanical diffusion. Still others may be caused by mechanical infusion, capture, folding or otherwise. The desired incorporation occurs at a nozzle pressure from 10 to 200 pounds per square inch (psi), more preferably 20 to 100 psi (from 138 to 689 kilo-pascals or kPa). Although this nozzle pressure may be suitable, nozzle pressure may range from approximately 10 to 100 psi, more preferably 20 to 60 psi, or even more preferably, from approximately 30 to 60 psi.

The volumetric flow rate through the nozzle during the impingement(s) range from approximately 5 to 2000 standard cubic feet per minute (scfm), even more preferably 6 to 1900 standard cubic feet per minute (scfm) (0.17 to 54 standard cubic meters per minute or scmm). The diametrical discharge opening nozzle size found preferred was from approximately 1/16″ to approximately ¾″ (from approximately 1.6 to 19 millimeters).

Based on the volumetric flow rate in combination with the nozzle discharge opening size, the exit velocity of treatment materials from the nozzle may be calculated or estimated. Nozzle pressure may be an indicator of exit velocity since the velocity of the treatment materials increases as the nozzle pressure increases for the same processing equipment. However, the actual velocity of treatment materials may also depend on other equipment configuration parameters, such as nozzle shape and/or other factors.

Dissociation of Treatment Materials

The energy transformation may cause dissociation reactions to occur. Such dissociation of the treatment materials provides smaller molecules or atoms to be freed. Such may also occur in the substrate. This, for example, may provide sulfur which is incorporated into the surface layer as was found in the surface layer of the treated piston sample described below when a mixture of MoS₂ and PTFE was used as treatment materials. The collision between the carrier media and substrate surface may also have sufficient kinetic energy to dissociate or partly dissociate PTFE or other treatment or surface materials. The dissociation of the compounds in the treatment materials and the incorporation of some of these elements or smaller molecules, atoms or parts thereof into the surface or subsurface layers are believed to be an important aspect of the mechanism for at least some of the processes according to these inventions.

Such a dissociation reaction or reactions may provide the sulfur which is incorporated into the surface layer as was found in the surface layer of the treated piston sample when a mixture of MoS₂ and PTFE was used as the primary treatment materials. It is likely that the collision between the impact or carrier media and substrate surface will also have sufficient kinetic energy to dissociate or partly dissociate treatment or substrate materials.

Alloying or Formation of Alloys

Observation indicates that accomplishing the alloying of the surface and sub-surface layers is dependent on relationships that may exist between the following: the chemical properties of the substrate and treatment materials, the physical properties of the substrate (such as physical geometry, roughness, grain structure, hardness, ductility or other properties. The physical properties of the carrier media (such as size, shape, density, hardness and ductility) also may significantly affect alloy formation and composition of the skin. The chemical and physical properties of the treatment material or materials thus may vary from one process to another process and may involve known or future materials and configurations.

Folding and Diffusion of Substrate Surface Features

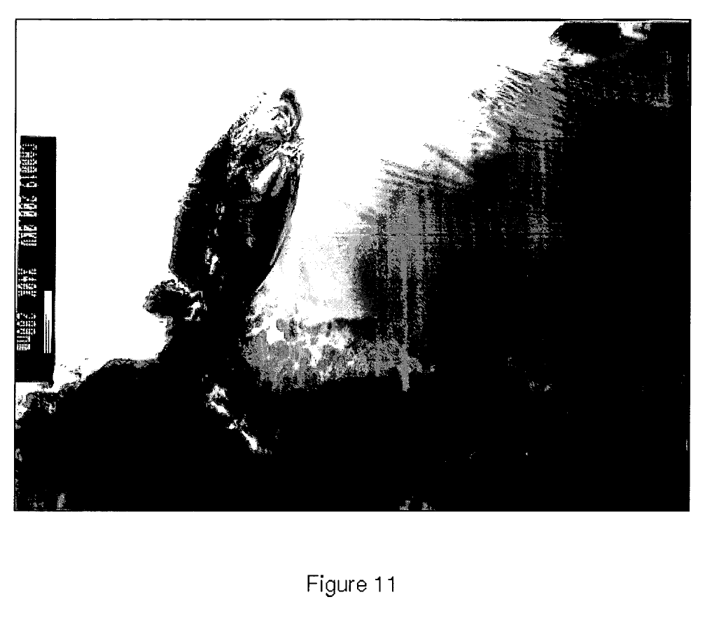

FIG. 11 shows in a high magnification image a protrusion of substrate forming a peninsular-shaped feature on the surface. To the right of the protrusion, near the base thereof, is an area showing a collection of molybdenum disulfide, polymer or other particles contained in or resulting from the materials and impingement processes. The photomicrograph shows how the treatment materials can be infused, diffused and/or otherwise incorporated. This may also occur in part by subsequent folding of the protrusion toward the right due to mechanical impact and energy release and resulting transformation. The bead-shaped particles may be captured and incorporated into the sub-surface zone. The left side of the protrusion shows surface alloying that has occurred. Beneath the protrusion can be seen a lighter colored area, and also similar lighter colored areas exist further to the right and beneath the surface. Thus, one or more of the treatment materials is infused, diffused, alloyed and otherwise incorporated by both the surface and sub-surface layers to change the surface and subsurface layers as a result of one or more of the processes explained herein.

Factors Affecting Treatments

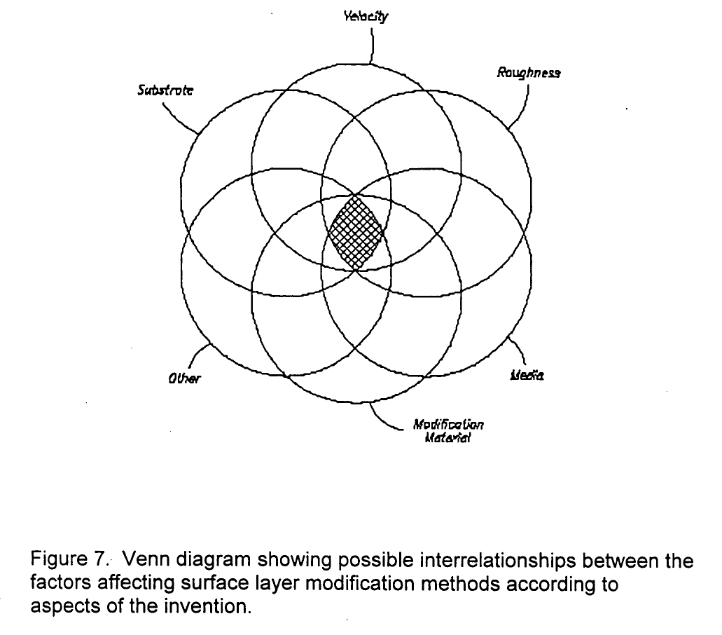

Some of the factors which influence the process include type of substrate, roughness of substrate, type of carrier media, type of other possible impact materials, type of treatment material(s) and the velocity of carrier and treatment materials. Without limitation to any particular factor or theory of operation, FIG. 7 is a Venn diagram graphically depicting some of the possible interrelationships between factors affecting the incorporation of the treatment material(s) into the alloy and diffusion layer. The hatched region in FIG. 7 represents a desirable combination of factors that produce such a layer. These factors may not be of equal significance in producing conditions effective to modify the chemical composition of a surface layer. Conventional techniques using peening and/or blasting methods have not addressed these processing factors to produce modifications to the chemical composition of a surface skin layer as taught herein. Although the exact combination of these factors will depend on the substrate, treatment materials, desired effects of treatment, and the application, described are a variety of process parameters that have been demonstrated to produce desired results.

Surface Changes

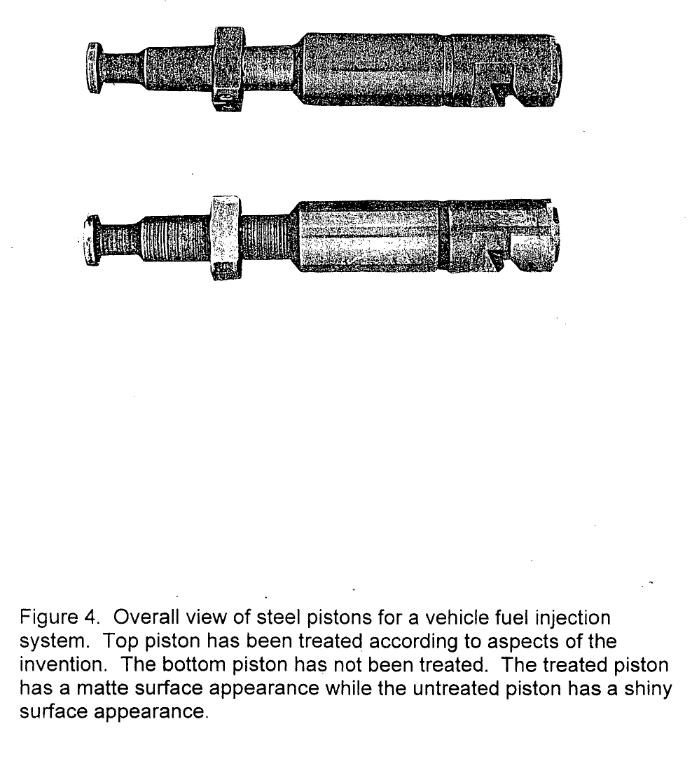

FIG. 4 shows the surface appearance of treated and untreated pistons which are merely one type of suitable component which may be treated according to the invention. The surface of the treated piston (top of photograph) has been slightly roughened to produce a texturized surface having a matte type of finish. This type of surface is believed to reduce metal-to-metal contact and may help entrap lubricant, both of which increase lubricity and usually help reduce friction. The untreated piston (bottom of photograph) has a shiny surface appearance. This type of surface increases metal-to-metal contact and may result in decreased lubricity compared to the matte finish.

Higher magnification micrographs of untreated and treated piston surfaces are shown in FIGS. 5 and 6 respectively. The treated surfaces shown in FIG. 6 have a greater average surface roughness than the untreated surfaces shown in FIG. 5. The rougher surfaces produced by the treatment help to reduce metal contact and may enhance entrapment of lubricant, with the result of increasing lubricity and reducing the coefficient of friction.

The effect of treatment on the tribological performance of frictionally engaged parts, such as in internal combustion engine parts, was determined by measuring the time to failure for treated and untreated cam lobes and lifters. The cam lobes and lifters were subjected to simulated engine speeds and pressures and were run to failure. The results from this test indicated that the treated parts lasted 90% longer than the non-treated parts. The increase in the lifetime of the treated parts may be associated with decreased metal-to-metal contact, increased lubricant entrapment, a lower coefficient of friction, hardened surface layer, possible improved dry lubricity, or combinations thereof and/or not yet understood phenomena.

Subsurface Treatment Zone or Zones Formed

Scanning electron microscopy (SEM) analysis indicated that the skin, which is the surface and subsurface layer together, in the treated piston was continuous and ranged in depths from 12 micro-inches to 40 micro-inches (0.3 micrometers to 1.0 micrometers), from the outer surface. The testing also produced an average depth of approximately 25 micro-inches (0.6 micrometers).

Dimensional Changes

As was previously stated, the skin produced using exemplary novel processes according hereto does not cause dimensional increase of the treated components. This is because the alloyed, infused, diffused or otherwise incorporated layer is not an additional coating on the surface, but is formed by the incorporation of one or more elements, compounds, or other portions of the treatment material or materials into the surface and beneath to form a skin layer, in situ.

Dimensional change experienced by the treated component or treated area thereof resulting from the novel processes is desirably within an approximate range of 0 to approximately −200 micro-inches; more preferably, from 0 to approximately −150 micro-inches; more preferably +0 to −100 micro-inches, even more preferable +0 to −50 micro-inches. Since lower dimensional change helps ensure that components do not exceed or significantly deviate from the dimensional tolerance specifications, dimensional change may be specified within more narrow ranges, such as approximately +0 to −20 micro-inches (−0.5 micrometers).

### EXAMPLES

### Example 1

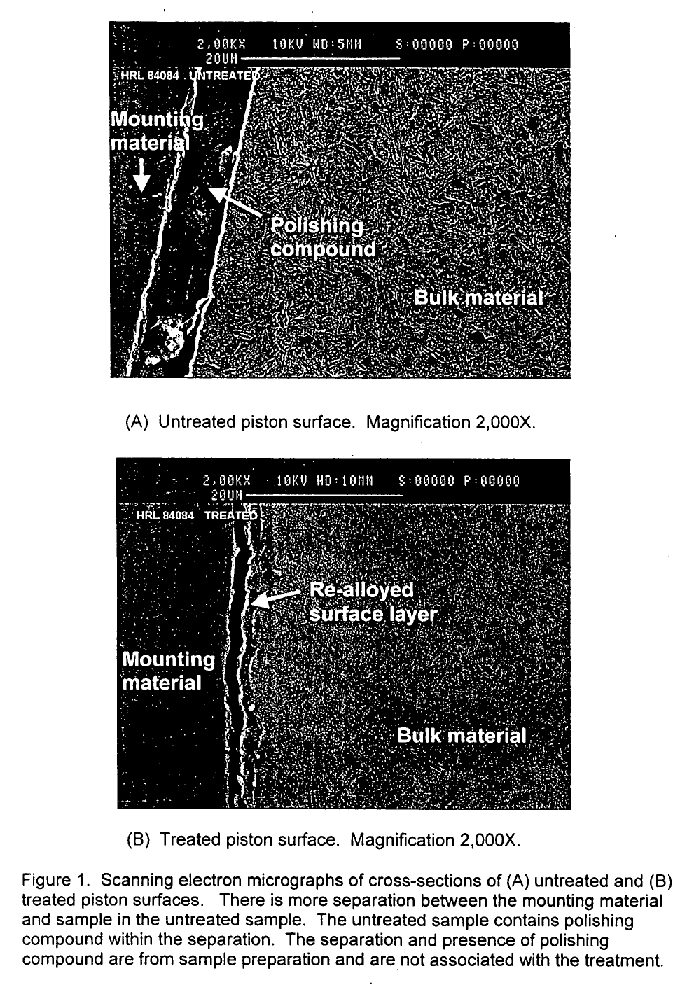

FIGS. 1, 2 and 3 are micrographs obtained from a scanning electron microscope (SEM) showing cross-sections prepared from samples of stainless steel pistons. One piston was left in the untreated condition while the other was treated according to aspects of the inventions.

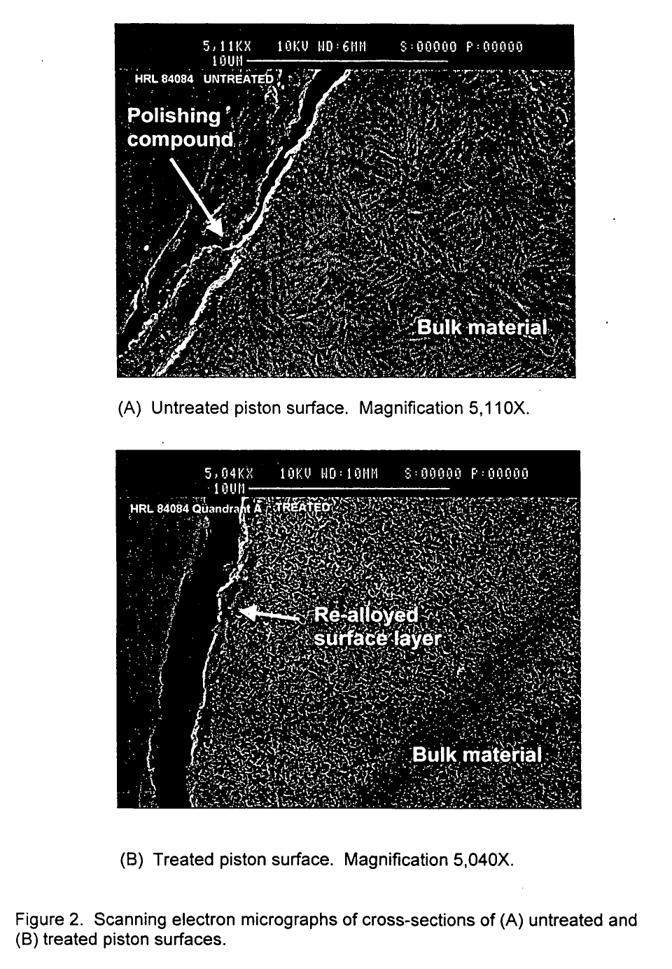

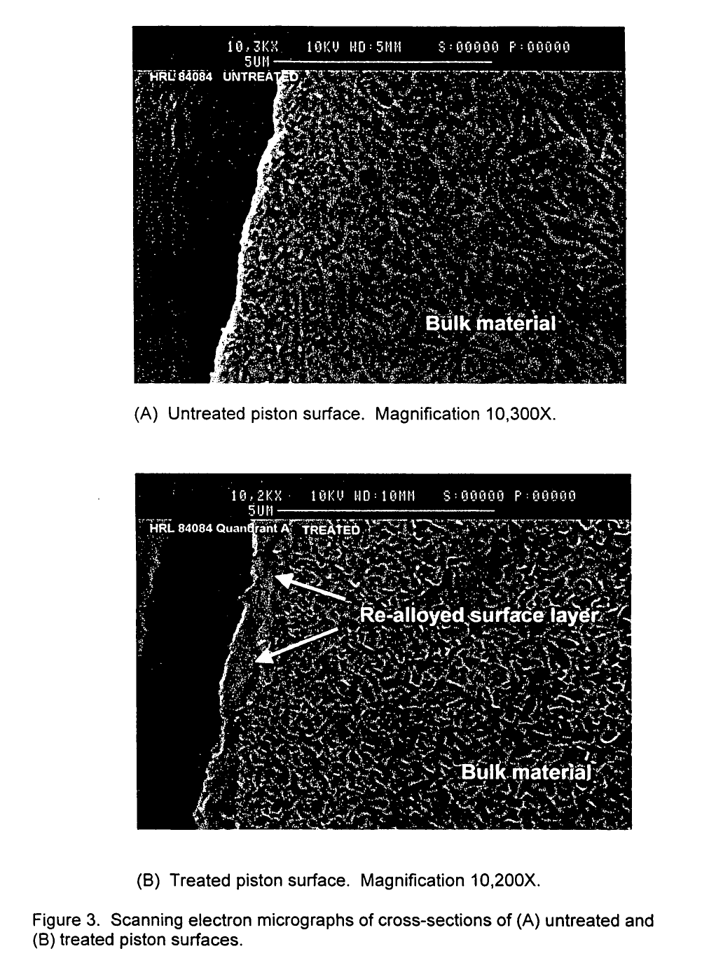

The treated piston was processed by using Al₂O₃ grit in the first impingement process; and by using a treatment material mixture composed of MoS₂ and PTFE which was mixed with a stainless steel shot carrier and impact media in the second impingement process. Each figure compares an untreated piston to a treated piston at a specific magnification. The magnifications used were 2,000× (FIG. 1), 5,000× (FIG. 2) and 10,000× (FIG. 3).

The cross-sectional micrographs of the treated piston surface show a defined or distinct treatment zone layer which was absent in the untreated piston surface. Energy dispersive spectroscopy (EDS) was used to determine if there were differences between the elemental composition of the surface layer and the substrate metal composition.

As shown, the substrate metal contained approximately 94% iron, approximately 2% chromium and approximately 4% silicon. The skin layer formed in the treated piston contained approximately 65% iron, approximately 27% sulfur, approximately 7% aluminum and approximately 1% silicon.

The major differences between the compositions of the developed treatment layer or skin and the substrate metal were: (1) the surface layer contained approximately 27% sulfur while no sulfur was present in the substrate metal; and, (2) the surface layer or in situdeveloped skin contained approximately 7% of aluminum while no aluminum was present in the substrate metal.

The sulfur in the treated piston surface layer is believed to be infused or otherwise incorporated from the MoS₂ used in the treatment material in the second impingement process. The aluminum in the treated piston surface layer is believed to be from the Al₂O₃ used in the first impingement process. The sulfur and aluminum was incorporated into the steel and formed a treatment layer which may be referred to as an alloy and diffusion layer or skin in some descriptions given herein according to various forms of the inventions.

The cross-sectional SEM micrographs of the untreated piston do not show an alloy and diffusion layer formed at the surface into a subsurface zone. Diffusion layer and EDS results indicated that there were no compositional differences between the untreated piston surface areas and the substrate material.

SEM analysis indicated that the treatment zone layer in the treated piston was continuous and ranged in depth from 12 micro-inches to 40 micro-inches (0.3 micrometers to 1.0 micrometers), with an average depth of approximately 25 micro-inches (0.6 micrometers). The alloyed or modified skin layer containing the surface layer and subsurface layer ranges from approximately 12 to approximately 40 micro-inches and does not cause substantial dimensional change of the treated component. This is because the alloy and diffusion layer is not an additional coating on the surface. This may advantageously be done using the first and second impingement processes performed to affect the surface of the substrate. Such may be some of the causative factors that the treatment processes described in these inventions do not significantly change the dimensions of the substrate between before and after treatment.

The range of thickness associated with the sub-surface zone wherein one or more alloy or diffusion layers are produced hereto may have depths lesser or greater than the thickness of the skin formed in this example. In preferred versions, this layer is formed by changing the composition of the surface and preexisting substrate laying below the surface. Thus, the combined surface and subsurface layer or skin formed does not significantly change the dimensions of the treated part.

FIG. 4 shows the surface appearance of the treated and untreated pistons which are merely one type of suitable component which may be treated according to the invention. The surface of the treated piston (top of photograph) has been slightly roughened to produce a matte type of finish. This type of surface reduces metal-to-metal contact and may help entrap lubricant, both of which increase lubricity and reduce friction. The untreated piston (bottom of photograph) has a shiny surface appearance. This type of surface on this workpiece demonstrates increased metal-to-metal contact and may result in decreased dry and wet lubricity compared to the matte finish provided by the treatment processes according hereto.

Higher magnification micrographs of untreated and treated piston surfaces are shown in FIGS. 5 and 6, respectively. The treated surfaces shown in FIG. 6 have a higher surface roughness than the untreated surfaces shown in FIG. 5. The rougher surfaces produced by the treatment help to reduce metal contact and may enhance entrapment of lubricant, with the result of increasing lubricity and reducing the coefficient of friction.

In the case of carrier media coated with MoS₂ particles, theoretical calculations indicate that the energy transferred to the substrate surface from the impingement of 1 kg of carrier media is sufficient to dissociate or partly dissociate the MoS₂ present on the surface of the carrier media into individual molybdenum and sulfur atoms. This or other possible dissociation may provide the sulfur which is incorporated into the surface layer as was found in the surface layer of the treated piston sample when a mixture of MoS₂ and PTFE was used as a treatment material. It is likely that the collision between the carrier media and substrate surface will also have sufficient kinetic energy to dissociate or partly dissociate PTFE. The dissociation of the compounds in the modifying media and the incorporation of some of these elements into the surface layer is a notable aspect of the mechanism for this process.

A variety of attempts have been made in the art to use the kinetic energy of peening and/or blasting to alter the surface properties of metallic components. However, the results of conventional techniques produce an added layer wherein the properties of the added layer are the source for the surface property alteration. Such conventional techniques are distinguished from aspects of this invention in that the treatment material in this invention is incorporated into a surface layer by infusing elements or compounds without producing a substantial dimensional change in the material. As indicated, the infusion modified subsurface layer can have a depth preferably in the approximate range of 1-100 micro-inches, more preferably in the approximate range of 5-50 micro-inches, even more preferably of approximately 10-50 micro-inches, still more preferably 12 to 40 micro-inches (0.3 to 1.0 micrometer) within the original dimensions of the substrate.

The steps in one preferred surface and subsurface alloying method are as follows. The first step is pre-cleaning the substrate which may involve using a cloth optionally dampened with a cleaning material. FIG. 8 shows a substrate (labeled as 10) on which surface debris (labeled as 12) exists prior to pre-cleaning. The first impingement may include dry blasting the substrate with an abrasive cleaning media entrained in a carrier gas. The cleaning media is an abrasive material, which is applied at a nozzle angle from 0° to 90°, more preferably 10° to 90°. The second impingement used in this embodiment or version of the invention impinges the substrate using a modifying treatment mixture containing treatment material and carrier media, both of which are entrained in a carrier fluid, preferably a carrier gas, such as air.

FIG. 9 shows the orientation of the nozzle (labeled as 14) at a nozzle angle of θ with respect to the substrate surface. If the substrate surface is curved, θ is defined with respect to a tangent line to the surface. The diagram in FIG. 9 is a diagrammatic depiction of the apparatus used in the dry material impingement processes. Depending on the curvature of the surface, the nozzle angle may vary throughout a surface alloying method as the nozzle travels across the substrate during the first, second or other impingement processes.

Methods according hereto include alloying a surface layer and sub-surface layer of the substrate by incorporating at least a portion of the treatment material into the surface layer without substantially adding treatment material over the surface layer. FIG. 10 shows a substrate (labeled as 10) with a alloyed surface layer (labeled as 16) that is modified in its chemical composition after the impingement processes which incorporate at least portions of treatment materials into the surface. Notably, the surface layer does not demonstrate substantial dimensional change compared to the surface of the untreated substrate. The method may also include post-cleaning the treated workpiece.

Pre-cleaning the substrate and/or first impinging the substrate with a cleaning agent or agents has been found to improve the effectiveness of the second impingement treatment which produces the alloying of the surface. Without being limited to any particular theory, a few possible reasons as to why pre-cleaning and/or first impinging may make a difference are presented herein.

It is believed that pre-cleaning maximizes the opportunity for penetration of the treatment material into the substrate. Also, minor surface inconsistencies, such as machining and/or forming marks from prior fabrication methods, may decrease the effectiveness of alloying even though the presence of these surface inconsistencies may not detrimentally affect conventional coating methods. Experience indicates that reducing the presence of surface inconsistencies by pre-cleaning and/or first impingement results in improved alloying results. Also, pre-cleaning and/or first impingement provides a uniform surface which allows for more complete penetration of treatment material into the surface of the substrate. This, in turn, increases the homogeneity of the alloyed surface layer and establishes uniformity in the desirable surface properties produced by this treatment.

Similarly, surface impurities and/or oils may be present on a substrate from prior fabrication methods. Surface impurities and/or oils may act as a barrier which reduces penetration of treatment material into the surface. Also, surface impurities and/or oils may lubricate the substrate, allowing modifying media to ricochet from the substrate without fully reacting with the substrate. The interaction of treatment material with the surface may also be affected if the momentum associated with the collision of the treatment material and the surface is changed by the presence of surface impurities or contaminants on the surface. Lack of sufficient kinetic energy associated with the collision may hinder adequate alloying of the surface.

Further, the first impingement step may uniformly texturize the substrate surface to create cavities where the treatment material may accumulate on the substrate during the second impingement step. This would allow the treatment material to become infused and mechanically folded into the surface. After mechanical folding into the surface, the elements in the treatment material may diffuse more deeply into the surface layer as a result of the kinetic energy associated with the second impingement step.

After pre-cleaning and/or first impingement, the second impingement may use a treatment material that is either different from, or the same as, the material(s) used in the first impingement. The second impingement may include peening with steel shot or glass bead. In either the first or second impingement, the carrier gas may include compressed air, among other suitable carrier gases, such as those currently known to those of ordinary skill or others hereafter developed. For example, an inert carrier gas may be used if the surface alloying process is required to occur in an inert atmosphere. Alternatively, certain mixtures of gases or other fluids may facilitate alloying, diffusion or other incorporation of materials.

The second impingement may be performed at a nozzle pressure from 10 to 200 pounds per inch² (psi), more preferably 20 to 100 psi, (from 138 to 689 kilo-pascals or kPa). Although this nozzle pressure may be suitable, nozzle pressure may range from approximately 10 to 100, more preferably 20 to 60 psi, or even more preferably, from approximately 30 to 60 psi.

The volumetric flow rate through the nozzle during the first or second impingement ranges from approximately 5 to 2000 standard cubic feet per minute (scfm), even more preferably 6 to 1900 standard cubic feet per minute (scfm) (0.17 to 54 standard cubic meters per minute or scmm). The nozzle size used was from approximately 1/16″ to approximately ¾″ (from 1.6 to 19 millimeters).

Based on the volumetric flow rate in combination with the nozzle size, those of ordinary skill may calculate an exit velocity of treatment materials from the nozzle. Nozzle pressure is an indicator of exit velocity since the velocity of the materials increases as the nozzle pressure increases for the same processing equipment. However, the actual velocity may also depend on equipment configuration, such as nozzle size and volumetric flow rate and dispensing shape and configuration.

Instead of a rotary-type of blending apparatus, a split mixing apparatus, such as a V-mixer (now known or hereafter developed), or other suitable mixers, tends to reduce static charge buildup and may be preferred. In addition, the treatment material tends to adhere to the carrier media better when prepared in a split mixing apparatus, and there is a more uniform distribution of the treatment material in the carrier media. A more uniform distribution of treatment material in the carrier media may contribute to a more uniform alloying of surface and subsurface layers on the substrate.

The roughness obtained during first impingement may vary according to the substrate and cleaning media properties. For example, steel shot tends to produce a rougher surface in comparison to glass bead. Cleaning media size may also influence roughness obtained. An average surface roughness, Rₐ, of about 0.4 micro-inches (0.01 micrometers), has been found suitable for alloying of a surface layer using treatment media composed of a mixture of molybdenum disulfide and PTFE; however, a different surface roughness may be required for alloying other materials.

There are situations where higher surface roughness may detrimentally affect the desired surface properties. In these situations, it is not advantageous to make the substrate too rough. Depending on the design specifications of the final component, cleaning material(s) may be selected depending upon the mechanical properties of the substrate to provide adequate roughness for the second impingement step without increasing surface roughness to the extent where it becomes deleterious to the product application.

Similar considerations exist with regard to selecting carrier media for the second impingement step. Preferably, the second impingement applies the treatment material and imparts sufficient kinetic energy to promote alloying of the surface without further roughening the substrate beyond the roughness obtained during the first impingement. Accordingly, depending upon the substrate mechanical properties and design specifications of the final component, carrier media in the second impingement step may be selected to provide the desired effects.

A further relationship may exist between treatment materials. For example, PTFE and/or molybdenum disulfide may be used to decrease the coefficient of friction between contacting surfaces, hence improving the lubricity. Observation indicates that using 100 weight % (wt %) PTFE as a treatment material is not significantly effective in causing alloying of the surface. Also, for mixtures high in molybdenum disulfide, using at least 95 wt % molybdenum disulfide with the remainder of the mixture as PTFE, did not satisfactorily increase lubricity. Decreasing the amount of PTFE from 100 wt % to 50 wt % with the remainder of the mixture being molybdenum disulfide also did not significantly alloy the surface to improve lubricity. Decreasing the amount of PTFE from 5 wt % to 50 wt % with the remainder of the mixture being molybdenum disulfide improved lubricity in comparison to the other compositions. Even though PTFE and molybdenum disulfide do not individually appear to significantly increase lubricity, a synergistic effect which provided very significant lubricity improvements was observed to occur within the compositional ranges described. For example, treatment ranges of 5 wt % PTFE and 95% MoS₂ to less than 50 wt % PTFE and 50 wt % MoS₂ are preferred. More preferably, ranges for these treatment materials are 10 wt % PTFE and 90 wt % MoS₂ to 40 wt % PTFE and 60% MoS₂ are also preferred. Still further ranges of 20 wt % PTFE and 80 wt % MoS₂ to 30 wt % PTFE and 70 wt % MoS₂ may further be advantageous. All weight percentages indicated are exclusive of the carrier or impact component(s) of the jetted, impinging treatment materials.

In accordance with a further aspect of the invention, a surface alloying method includes pre-cleaning a substrate with suitable applicator, such as a cloth optionally dampened with a cleaning material. The method may further include impinging the substrate with a cleaning media at a nozzle angle from 10° to 90° in a first impinging step. The first impinging step may be followed by a second impinging step, such as by impinging the substrate with a carrier media mixed with treatment material at a nozzle orientation angle from 10° to 90°. The first impingement occurs in a first enclosure and uses a nozzle pressure from 10 to 190 psi. The second impinging may advantageously be performing such step in a second enclosure and using a nozzle pressure from 20 to 60 psi.

As an example, the cleaning material optionally used in pre-cleaning the substrate with a cloth may include water, acetone, mineral spirits, solvents, surfactants, or various combinations thereof. In the event that surface impurities and/or oils are not adequately removed by decontaminating or by the first impingement step, pre-cleaning with a cleaning material may assist in removing undesirable contaminants. Similarly, the post-cleaning step may include applying suitable post-cleaning material, such as a cloth optionally dampened with suitable cleaning materials, for example, solvents, water solutions or many other materials.

Post-cleaning may also, or instead, include applying a stream of compressed gas, polishing in a tumbler with an abrasive media (such as garnet), sonic cleaning, or combinations thereof. One objective of the post-cleaning is to remove any residue from the treatment material. Since the surface layer of the substrate is alloyed or otherwise infused with at least some of the treatment material or materials. Excess treatment material may be removed without impacting or otherwise affecting the desired properties of the alloyed surface skin layer.

Also, as an example of alternatives, the nozzle angle in the first or second impingement step may instead be from 30° to 90°, or from 70° to 90° to provide direct impingement. Adjusting the nozzle angle may produce a roughening effect on the substrate, and/or change the amount of kinetic energy transferred to the substrate. Both of these effects may influence the incorporation of treatment materials into the surface layer. Also, the nozzle pressure during the first impingement step may range from 30 to 100 psi. Nozzle pressure during the second impingement step may be within the ranges described previously.

It may be desirable to perform the surface alloying and incorporation methods such that the first impingement process occurs in an enclosure which is different from the enclosure used for the second impingement process. In this manner, the cleaning material used in the first impingement step can be segregated from the carrier media mixed with treatment material that is used in the second impingement step. One advantage of the aspects of the invention described herein is that used treatment material typically will be reusable after performing the method on a particular component. The carrier media and treatment material mixture applied to a component may be collected from the second enclosure and returned to a feed mechanism for performing the second impingement process on another component. Accordingly, assuming that the treatment material and carrier media are not troublesome toxic materials, no toxic by-products are produced from the aspects of the invention described herein. Even if the treatment material or carrier media are toxic materials, they may be largely recycled to the feed for the second impingement process if processing occurs in a fully enclosed vessel with a sealed interior treatment chamber.

### Example 2

A 316 stainless steel ring was processed by dry blasting the ring with garnet to clean and roughen the surface in preparation for accepting a molybdenum disulfide and PTFE chemical mixture. The garnet media was applied through a 5/16″, 12 scfm size nozzle in a blasting cabinet. The nozzle angle was 90° and the nozzle was positioned 4″ from the ring surface. Supplied air pressure was 50 psi while delivering the garnet particles in a sweeping motion covering the surface of the ring twice to help ensure complete treatment of the surface. After treatment, a stream of compressed air was applied to the ring to help remove any remaining garnet media.

The ring was removed from the blasting cabinet and placed in a peening cabinet. A mixture of molybdenum disulfide, PTFE, and fine steel shot was applied to the ring through a 5/16″, 24 scfm size nozzle at a nozzle angle of 90°. The ring was approximately 4″ to 5″ from the nozzle tip. The chemical mixture was applied with 60 psi of pressurized air in a sweeping motion that covered the ring surface four times to ensure complete coverage as well as penetration. After application, residual powder was blown from the ring surface with a stream of compressed air and the ring was wiped down with a clean dry cloth. The treated ring had a gray matte finish compared to the shiny metallic finish of the unprocessed ring. Testing of this ring indicated a decrease in the coefficient of friction.

### Example 3

An aluminum 6061-T6 ring was processed by dry blasting the ring with aluminum oxide to clean and roughen the surface in preparation for accepting a molybdenum disulfide and PTFE chemical mixture. The aluminum oxide media was applied through a 5/16″, 12 scfm size nozzle in a blasting cabinet. The nozzle angle was 90° and the nozzle was positioned 4″ from the ring surface. Supplied air pressure was 30 psi while delivering the aluminum oxide media in a sweeping motion covering the surface of the ring twice to help ensure complete treatment of the surface. After treatment, a stream of compressed air was applied to the ring to remove remaining aluminum oxide media. The ring was removed from the blasting cabinet and placed in a peening cabinet. A mixture of molybdenum disulfide, PTFE, and fine steel shot was applied to the ring through a 5/16″, 24 scfm size nozzle at a nozzle angle of approximately 90°. The ring was approximately 4″ to 5″ from the nozzle tip. The chemical mixture was applied with 30 psi of pressurized air in a sweeping motion that covered the ring surface four times to help ensure complete coverage as well as improved penetration. After application, residual powder was blown from the ring surface with a stream of compressed air and the ring was wiped down with a clean dry cloth. The treated ring had a matte finish compared to the shiny metallic finish of the unprocessed ring.

### Example 4

A 316 stainless steel ⅜″ high pressure fitting nut with a 0.035″ wall thickness was processed by dry blasting the fitting nut with fine glass bead to clean and roughen the surface in preparation for accepting a molybdenum disulfide and PTFE chemical mixture. The fine glass bead media was applied through a 5/16″, 12 scfm size nozzle in a blasting cabinet. The nozzle angle was 90° and the nozzle was positioned 3″ from the fitting nut surface. Supplied air pressure was 60 psi while delivering the fine glass bead media in a sweeping motion covering the surface of the fitting nut twice to ensure complete treatment of the surface. After treatment, a stream of compressed air was applied to the fitting nut to remove any remaining fine glass bead media.

The fitting nut was removed from the blasting cabinet and placed in a peening cabinet. A mixture of molybdenum disulfide, PTFE, and fine glass bead was applied to the fitting nut through a 5/16″, 24 scfm size nozzle at a nozzle angle of 90°. The fitting nut was approximately 4″ to 5″ from the nozzle tip. The chemical mixture was applied with 60 psi of pressurized air in a sweeping motion that covered the fitting nut surface four times to help ensure complete coverage as well as penetration. After application, residual powder was blown from the fitting nut surface with a stream of compressed air and the fitting nut was wiped down with a clean dry cloth.

One exemplary benefit found associated with the treatment process of Example 4 was to reduce the amount of torque required to tighten a fitting nut for stainless steel seamless tubing. A torque comparison between three untreated fitting nuts and three fitting nuts treated as described above indicated that the treated fitting nuts resulted in an approximately 23% decrease in the torque required to tighten the nuts.

One important criterion of the treatment method was to avoid damage to the fine threads on the experimentally treated fittings. Treatment of the fitting nut did not noticeably damage the threads.

Apparatuses

General Layout

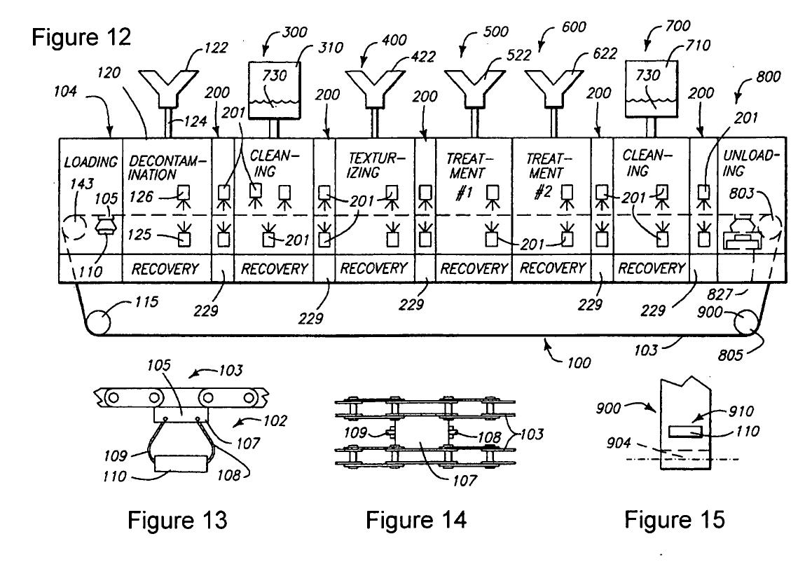

FIGS. 12-15 show a preferred processing apparatus or system 100 according to certain aspects of the inventions described herein. Apparatus 100 has a plurality of stations or stages of processing shown. More specifically the system illustrated has a loading section 104, a decontamination station 120, several gas impingement de-dusting or drying sections 200, a solvent cleaning section 300, a texturizing section 400, a treatment section 500, a treatment section 600, a solvent cleaning station 700, and an unloading section 800.

A conveyor 103 is advantageously used to move workpieces 110 (see FIG. 13) through the series of stations. Workpieces 110 are loaded in the loading section 104 and unloaded after processing at the unloading station 800. The loading and unloading sections may be selected from a number of suitable forms or types. The processed workpieces are then conveyed out of the system using an unloaded workpiece conveyor 900 (FIG. 15). The operation of these various sections will be described in greater detail hereinbelow.

Workpiece Conveyor

The workpiece conveyor 103 shown herein advantageously utilizes a circuitous conveyor, such as a bendable conveyor loop with strand or strands trained about guide rollers, chain sprockets or the like. As shown, the bendable circuitous conveyor utilizes parallel roller chains which act as parallel conveyor strands. This is best shown in FIG. 14. In the conveyor shown the apparatus has a converor drive, such as an electric motor (not illustrated) connected to a drive sprocket 115 to cause motion, particularly circuitous motion of the conveyor. Other types of conveyors now known or hereafter developed may be suitable for use in the systems according to this invention.

The workpiece conveyor also preferably has a workpiece engagement part. As shown, this is provided in the form of engagement part 105. Engagement part 105 is suitably mounted on the conveyor, such as by connection to the illustrated parallel roller chain strands. Mounting will vary depending on the size of the engagement part and workpieces being treated and the type of engagement part used.

As shown, engagement part 105 includes a body 107 which preferably contains an actuation mechanism therein. A variety of actuation mechanisms may be used. The body 107 also mounts the engagement elements, such as engagement arms 108 and 109 that contact the workpiece 110 and hold the workpiece as it is being conveyed. The number of engagement parts used on the system will depend on the processing parameters and other factors of the production system and processes being performed therein. The engagement arms are contracted or closed and retracted or opened using any suitable actuator or actuators (not shown) which may be mechanical, electrical, magnetic or combinations thereof.

Loading Section

FIG. 12 also shows a loading section 104. In the loading section the workpieces are fed into the system and positioned to be engaged and held by the engagement part 105. The exact feeding arrangement will vary as needed or desired for the particular workpiece being conveyed and the engagement part and how the engagement arms or other workpiece holders operate to engage and hold the workpieces.

Decontamination Section(s)

As shown, automated treatment system 100 has the loading section 104 at one end. A decontamination section 120 is adjacent to the loading section to remove contaminating materials that may be present on the workpieces being treated. The decontamination section 120 may be preferred where the workpieces are contaminated with large amounts of debris or where one or more chemicals or other materials are present and it is desirable to independently remove such contaminants prior to any further processing. For example, the workpiece might have a chemical thereon which is used to facilitate production of the workpiece. If such contaminant is dangerous or difficult to handle, or if the residue removed from the incoming workpiece must be specially handled due to environmental concerns or standards, then a suitable fluid is jetted or sprayed so as to impinge upon the workpiece 110 using one or more decontamination fluids emitted from decontamination emitters 125 and 126. The emitters may emit the same or different chemicals which with the removed contaminant or contaminants from the workpiece are collected by a recovery section in the decontamination section.

If the decontamination section requires application of decontaminating materials which are in particulate or other solid form, then a decontamination material mixer 122 may be used. As shown, mixer 122 is capable of multiple decontamination materials and is mounted above the conveyor to feed the cleaning stage 300. Alternatively the decontamination section 120 may use fluids that do not require a mixer 122 and can be fed to the emitters 125 and 126 from a tank or other source using feed line 124. The source may be from outside the system 100 if desired.

The decontamination section 120 may be followed by a cleaning or drying section or sections 200. As shown, a suitable fluid, such as air or solvent, or multiple cleaning fluids may be emitted from one or more emitters 201. The emitters for this and other sections may be provided at various different places along the conveyor or at various orientations to best accomplish the function for the type of workpiece being treated and the treatment materials being used.

Cleaning Sections

FIG. 12 also shows a fluid cleaning section 300. As shown, section 300 is adapted to spray a cleaning liquid 730, such as a solvent or other suitable liquid. Such liquid is stored in a cleaning liquid reservoir 310. The liquid 730 may be sprayed or otherwise emitted by emitters 201 from various longitudinal positions and radial orientations as found best for the particular workpieces and cleaning liquid being used.

Drying Sections

FIG. 12 also shows a drying section 200 after cleaning section 300 for purposes of drying the cleaning liquid 730 from the workpieces. A suitable drying gas, such as air, nitrogen, argon or other gas as desired or required is jetted upon the workpieces 201. Liquid may be collected in collector 229. The collected liquid or other material may be disposed of in various ways or recycled as is appropriate.

Substrate Texturizing Sections

The system 100 also is preferably provided with a texturizing section 400. As shown, the texturizing section is provided in a separate section and separate container so as to contain the texturizing material or materials being used. This may be desired for a number of different reasons, such as recovery or simply to minimize carryover to the adjacent sections.

Texturizing section 400, as shown, is constructed to provide one or more particulate texturizing materials using a mixer 422 or other suitable texturizing material feeder(s). For example, it may be found in some instances that the desired texturizing of the substrate material of the workpiece is best texturized by using grit of two different types or sizes. The texturizing material or materials are fed from the mixer 422 to one or more emitters 201 which are positioned to jet from various longitudinal positions and radial orientations as found best for the particular workpieces and texturizing materials being used.

The texturizing materials may advantageously be recovered, if appropriate. FIG. 12 shows a bottom recovery section to section 400 to recover the texturizing materials for reuse.

First and Other De-Dusting Sections

FIG. 12 also shows a de-dusting section 200 advantageously included after the texturizing section 400 to de-dust the workpieces advancing therefrom. The de-dusting section may be used similar to the drying section described above. For example, the de-dusting may be accomplished by jetting air or other suitable fluid to impinge upon and remove residual texturizing materials remaining on the workpiece from the action of texturizing section 400. The catch chamber 229 may collect texturizing materials and such materials may be disposed of or recycled as is appropriate.

Treatment Sections

FIG. 12 also shows another section 500 for use in applying a desired treatment material to the workpieces which have been previously processed with one or more of the indicated sections. As shown, the section termed in the illustration treatment #1 receives the workpieces from the texturizing section 400 and any de-dusting section 200 included thereafter.

Treatment #1 section may be used to apply a desired treatment material or materials. As shown, the treatment #1 section may be used to apply a combined material, such as the PTFE and molybdenum disulfide (MoS₂) treatment described hereinabove. Other treatments described above may also be suitable at this stage. The treatment section 500 is advantageously provided with a dry material from a V-type mixer 522 which mixes two desired treatment materials. The mixer may use a combination of the active treatment materials in one section and carrier particles in the other feed section. Alternatively it may include two active materials which are each mixed with carrier and/or impact materials.

The treatment section 500 may use one or more emitters 201 which can be at various longitudinal and radial positions to provide multiple pass coverage over the entire exterior of the workpiece. A recovery section is included at the bottom of treatment section 500 to recover the excess materials jetted at the workpiece which do not adhere thereto so that such can be recovered and recycled for another workpiece or otherwise.

FIG. 12 further shows a second treatment section 600. As shown, second treatment section 600 may be used to apply the same materials as the first treatment section 500. It may alternatively be used to apply a different mix of materials. The configuration having sections 500 and 600 being placed immediately adjacent to one another is particularly appropriate where the second treatment section is used to apply the same treatment materials because no de-dusting is needed and it applies the treatment materials multiple times to assure sufficient coverage and effectiveness to the treated workpiece. Each treatment section may be provided with sufficient emitters for jetting the treatment materials at the workpieces to impinge the treatment materials thereon. By providing repeated passes over the workpiece within each treatment chamber the desired assurance of coverage and treatment may be provided.

It should further be appreciated that the use of two treatment sections may not be necessary depending upon the adhesion and results achieved using a single treatment section. Also, it is possible to have more than two treatment sections. Such multiple treatment section (not illustrated) may be used to provide multiple passes of the impinging jet, such as the four passes indicated desirable in some cases. They may also provide a series of treatments that are different, partly the same, or some the same and others different. This allows a variety of processes to be implemented and employed to provide automated processing with one or more treatment materials.

Second De-Dusting Section

FIG. 2 further shows a second de-dusting section 200 after the second treatment section 600. This de-dusting section is the same or similar to that described above positioned after the texturizing section 400. It similarly is used to remove residual materials, such as the treatment materials from sections 500 and 600. De-dusting section 200 thus can be used to remove and recover treatment materials. The recovered materials can be recycled, such as back to treatment sections 500 and 600 to reduce materials costs. Alternatively, the de-dusted material may be most suitable for disposal or recycling for another system different from system 100.

Second or Post-Cleaning Section

System 100 may also preferably have a second or post-cleaning section 700. Section 700 may be the same as or similar to the pre-cleaning section 300 described hereinabove. Alternatively, a different type of cleaning fluid may be employed to improve the condition of finished, treated workpieces.

As shown, post-cleaning section 700 has a reservoir 710 for holding a suitable cleaning fluid 730, such as those described above and other suitable fluids dependent upon the processes being employed. The fluids are emitted from emitters 201 which emit jets of fluid that impinge upon the workpiece to further remove any treatment materials not removed by the second de-dusting section 200. Again, a variety of different longitudinal or radial emitter positions and orientations may be employed as needed for the particular process being performed.

Second or Post-Treatment Drying Section

FIG. 12 further shows a drying section 200 after the post-cleaning section just described. This may use fluids, typically gases, as explained with regard to the drying section included after cleaning section 300. Alternatively, other drying fluids may be employed to perform in a manner best suited to drying the workpiece product to a condition most advantageous to subsequent handling or packaging.

Unloading Section

System 100 also preferably uses an unloading section 800 after the post-treatment drying section 200. The unloading section is shown diagrammatically from above in FIG. 15. A workpiece 110 is released by opening the engagement arms 108 and 109. The workpiece then is released onto an output conveyor 827. The output conveyor may be of various constructions. One constructions may be an elastomeric output conveyor belt 910 which is trained about a roller 904 which supports the output conveyor and rotates as the conveyor belt passes about the roller 904.

Workpiece 110 then moves on to a subsequent station or process, such as inspection or packaging (not shown).

Interpretation Note

The invention has been described in language directed to the current embodiments shown and described with regard to various structural and methodological features. The scope of the inventions described herein is not intended to be necessarily limited to the specific features shown and described. Other forms and equivalents for implementing the inventions can be made without departing from the scope of concepts properly protected hereby.

1. A process for treating a substrate having a treated surface upon a workpiece to provide a treated skin layer of changed chemical composition upon a treated area of the workpiece, comprising:
texturizing the treated area to provide a surface having a desired texture to facilitate further treatment;
jetting at least one stream containing at least one treatment material toward the treated area;
impinging the at least one stream with at least one treatment material contained therein against the treated area;
infusing at least part of said at least one treatment material into and through the surface of the treated area by said jetting and impinging said at least one stream possessing sufficient kinetic energy to cause incorporation of said at least one treatment material through the treated surface and into a subsurface treatment zone to form said treated skin layer;
alloying at least a part of said at least one treatment material with the treated area to cause at least one alloy reaction to occur in the treated skin zone;
whereby the treated skin zone is provided with improved friction and wear characteristics as compared to a workpiece which has not been treated according to said process and said treated workpiece is not enlarged compared to an untreated workpiece.

2. A method according to claim 1 wherein said infusing step includes folding at least portions of said treatment surface to incorporate at least part of said at least one treatment material into the skin treatment zone.

3. A method according to claim 1 wherein at least two treatment materials are mixed and a resulting mixture is impinged upon the workpiece.

4. A method according to claim 1 wherein the substrate is metallic.

5. A method according to claim 1 wherein the at least one treatment materials include a metallic and sulfur compound.

6. A workpiece treated by any of the processes of claims 1-5.

7. An apparatus forming a surface treatment system for automated treatment of workpieces to provide improved friction and wear characteristics, comprising:
at least one conveyor for moving workpieces through a series of sections at least some of which are enclosed;
at least one workpiece engagement part mounted upon said at least one conveyor for engaging workpieces so the workpieces move therewith;
at least one input station wherein workpieces are engaged by said at least one engagement part to engage the workpieces and move them as the at least one conveyor moves through at least one of said series of sections;
at least one texturizing section wherein a texturing material is jetted at and impinged upon the workpiece to treat at least one treatment surface on a workpiece to provide a desired workpiece surface texture;
at least one treatment section which includes at least one enclosed treatment chamber through which workpieces move in response to movement of said at least one conveyor;
at least one post-cleaning section for cleaning workpieces which have been treated by said at least one treatment section;
at least one unloading section wherein treated and cleaned workpieces are received from the at least one workpiece engagement part.

8. An apparatus according to claim 7 and further comprising at least one cleaning section wherein a workpiece is cleaned prior to moving into said at least one texturizing section.

9. An apparatus according to claim 7 and further comprising at least one decontamination section wherein the workpiece is decontaminated.

10. An apparatus according to claim 7 and further comprising:
at least one decontamination section wherein the workpiece is decontaminated;
at least one cleaning section wherein a workpiece is cleaned prior to moving into said at least one texturizing section.

11. An apparatus according to claim 7 and further comprising at least one de-dusting section wherein the workpiece is de-dusted.

12. An apparatus according to claim 7 wherein the at least one conveyor is circuitous.

13. An apparatus according to claim 7 wherein a plurality of said sections are enclosed and connected in adjacent positions.

14. An apparatus according to claim 7 wherein a plurality of said sections are enclosed.
